(19) United States
(12) Patent Application Publication
(10) Pub. No.: US 2024/0403025 A1
(43) Pub. Date: Dec. 5, 2024

(54) FLEET SERVER, METHOD AND COMPUTER READABLE STORAGE MEDIUM FOR UPDATING SOFTWARE FOR VEHICLE BASED ON GEO FENCE

(71) Applicants: HYUNDAI MOTOR COMPANY, Seoul (KR); KIA CORPORATION, Seoul (KR)

(72) Inventor: Eun Sang NOH, Hanam-si (KR)

(21) Appl. No.: 18/517,912

(22) Filed: Nov. 22, 2023

(30) Foreign Application Priority Data
Jun. 2, 2023 (KR) 10-2023-0071284

(51) Int. Cl. G06F 8/65

(52) U.S. Cl. CPC G06F 8/65

(57) ABSTRACT

A fleet server for an update of software for a vehicle based on geofence includes a communication interface, one or more processors, and a storage medium recording one or more programs configured to be executable by the one or more processors. The one or more programs include instructions for receiving vehicle information through the communication interface, determining whether an Over The Air (OTA) update is required based on the location information of the vehicle included in the vehicle information and a preset update environment, and transmitting an OTA update request of vehicle software for a vehicle having the vehicle number through the communication interface, when it is determined that an update is required, as a result of the determination. The preset update environment includes a geofence area set for each vehicle.

### CROSS-REFERENCE TO RELATED APPLICATION(S)

This application claims benefit of priority to Korean Patent Application No. 10-2023-0071284 filed on Jun. 2, 2023 in the Korean Intellectual Property Office, the disclosure of which is incorporated herein by reference in its entirety.

### TECHNICAL FIELD

The present disclosure relates to a fleet server, method, and a computer-readable storage medium for updating vehicle software based on a geofence.

### BACKGROUND

Over-the-Air (OTA) update technology enables the wireless downloading and updating of vehicle software, even when the vehicle is moving.

With this OTA update capability, a driver can directly update navigation software that is not safety related while the vehicle is moving.

However, because OTA updates are not supported for safety-related firmware software, the driver may have to invest time in visiting a service center for firmware updates.

This becomes particularly cumbersome in the case of a transportation company managing a plurality of commercial vehicles, as it is inconvenient for a vehicle manager to individually board each vehicle to perform software updates.

### SUMMARY

The present disclosure is directed to a fleet server, method, and computer-readable storage medium for updating vehicle software based on a geofence, in which firmware software related to safety may be updated without the hassle of spending time and visiting a service center, and all vehicles may be collectively updated without boarding the vehicles individually.

The present disclosure is also directed to a fleet server, method, and computer-readable storage medium for software updates for vehicles based on geofences, in which rapid action is possible in the event of an update failure and the reality of transporters who park vehicles in vacant lots near garages due to a lack of parking spaces may be reflected and updated.

The present disclosure is also directed to a fleet server, method, and computer-readable storage medium for updating vehicle software based on a geofence, in which idle time in the case of a transportation company may be significantly reduced, are provided.

According to an aspect of the present disclosure, a fleet server for an update of software for a vehicle based on geofence can include a communication interface; one or more processors; and a storage medium recording one or more programs configured to be executable by the one or more processors. The one or more programs include instructions for receiving vehicle information through the communication interface, the vehicle information including a vehicle number and location information of the vehicle; determining whether an Over The Air (OTA) update is required based on the location information of the vehicle included in the vehicle information and a preset update environment; and transmitting an OTA update request of vehicle software for a vehicle having the vehicle number through the communication interface, when it is determined that an OTA update is required, as a result of the determination. The preset update environment includes a geofence area set for each vehicle.

According to an aspect of the present disclosure, a method of updating software for a vehicle based on a geofence can include a first operation of receiving vehicle information, the vehicle information including a vehicle number and location information of the vehicle; a second operation of determining whether an OTA update is necessary based on the location information of the vehicle included in the vehicle information and a preset update environment; and a third operation of transmitting a OTA update request for vehicle software for a vehicle having the vehicle number when it is determined that an OTA update is necessary as a result of the determining. The preset update environment includes a geofence area set for each vehicle.

According to an aspect of the present disclosure, a computer-readable storage medium storing a program for executing the method described above on a computer is provided.

### BRIEF DESCRIPTION OF DRAWINGS

FIG. 1 is a diagram illustrating an example of an entire system including a fleet server for updating software for a vehicle based on a geofence.

FIG. 2 is a diagram illustrating an example of a process of setting a geofence area in an update environment.

FIG. 3A is a diagram illustrating an example of a process of setting update schedule information in an update environment.

FIG. 3B is a diagram illustrating an example of an update schedule set for each vehicle in FIG. 3A.

FIG. 4 is a flowchart illustrating an example of a method of updating software for a vehicle based on a geofence.

FIG. 5 is a block diagram of an example of a computing device that may implement, in whole or in part, a fleet server for geofence-based vehicle software update, a vehicle terminal, and an OTA server.

### DETAILED DESCRIPTION

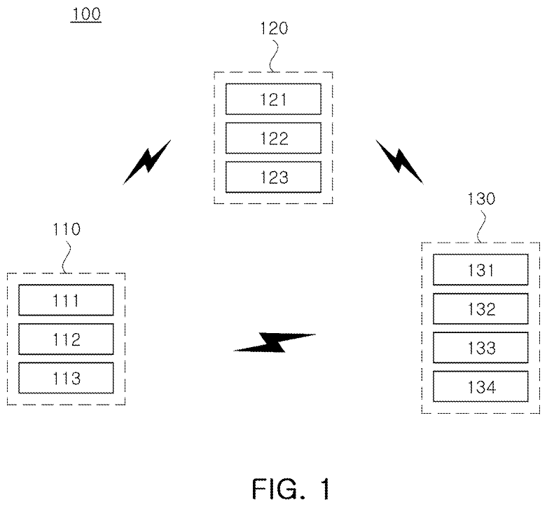

FIG. 1 is a diagram illustrating an entire system including a fleet server 130 for updating vehicle software based on a geofence. An entire system 100 may include a vehicle terminal 110, an OTA server 120, and a fleet server 130.

Geofence technology is a technology of setting a boundary, a virtual fence for a specific zone, based on a solution. Recently, geo-fencing location information technology has been combined with various services and applied to vehicle terminals. Thus, geofence is a compound word comprised of ‘geographic’ and ‘fence.’

First, the vehicle terminal 110 may include a control unit 111, a storage unit 112, and a communication interface 113, may be mounted on the vehicle and receive the latest version of vehicle software from the OTA server 120, and may update vehicle software of the previous version installed in the vehicle to a latest version of the vehicle software. The above-mentioned vehicle software is related to the safety of the vehicle and may be firmware software required to be updated while parked, but is not limited thereto. For example, the above-mentioned vehicle software may also be applied to software that may be updated while the vehicle is moving.

In detail, the control unit 111 may transmit vehicle information to the fleet server 130. In this case, the vehicle information includes vehicle number, location information, and parking status, and the parking status may include status information indicating whether or not the vehicle is parked. For example, a state in which the engine is turned off, a state in which the vehicle is in alert mode, or the like is a case in which the parking status is during parking, and safety related firmware software may be updated while parked.

In addition, the control unit 111 wirelessly receives the latest version of vehicle software from the OTA server 120, and update the vehicle software of the previous version installed in the vehicle to the latest version of the vehicle software. In addition, the control unit 111 may transmit the update result to the OTA server 120. In this case, the update result may include, for example, update success, update failure, update time, and the like.

The storage unit 112 may store various programs for implementing the functions performed by the control unit 111 described above.

The communication interface 113 may transmit/receive various types of data described above with the fleet server 130 and the OTA server 120 under the control of the control unit 111.

On the other hand, the Over-the-Air (OTA) server 120 may include a control unit 121, a storage unit 122, and a communication interface 123, and may be a server for supporting the vehicle terminal 110 to wirelessly download and update vehicle software.

In detail, the control unit 121 may transmit update status information for each vehicle to the fleet server 130. In this case, the update status information refers to whether an update is required or not. If the update status information is ‘update required,’ it means that an update is required. If the update status information is ‘update not required,’ it may be a case where an update is not required. In addition, when the control unit 121 receives an OTA update request including a vehicle number from the fleet server 130, the control unit 121 may transmit the latest version of vehicle software to a vehicle with a corresponding license plate number.

In addition, the control unit 121 may receive an update result from the vehicle terminal 110, and transmit the received update result to the fleet server 130.

The storage unit 122 may store various programs for implementing functions performed by the control unit 121 described above.

In addition, the storage unit 122 may store a vehicle number for each vehicle, vehicle software (including version), information on whether the vehicle software is safety-related firmware software or non-safety-related software, update status information, update date, and the like. With reference to the data stored in the above-described storage unit 122, the control unit 121 may manage vehicle software for each vehicle, and provide required data to the fleet server 130 and the vehicle terminal 110.

The communication interface 123 may transmit/receive various data described above with the vehicle terminal 110 and the fleet server 130 under the control of the control unit 121.

In addition, the OTA server 120 may also provide a website to which the above-described vehicle software developed may be updated or a website that may provide update status for each vehicle, for example, the version of vehicle software installed in a specific vehicle, and the like.

On the other hand, the fleet server 130 may include an input/output device 131, a control unit 132, a storage unit 133, and a communication interface 134, and may be a server for fleet management. In general, fleet management means overall management of various types of mobility assets such as cars, vans, trucks, trailers, and the like, but in the present disclosure, may refer to managing the update of vehicle software installed in the vehicle.

In detail, the fleet manager may set an update environment through the input/output device 131. In this case, the update environment may include a geofence area set for each vehicle and update schedule information set for each vehicle. The geofence area may be a garage area (a concept including a parking lot) or an area extended from the boundary of the garage area. In addition, the update schedule information may include a vehicle number, update status information indicating whether an update is necessary, and an update schedule.

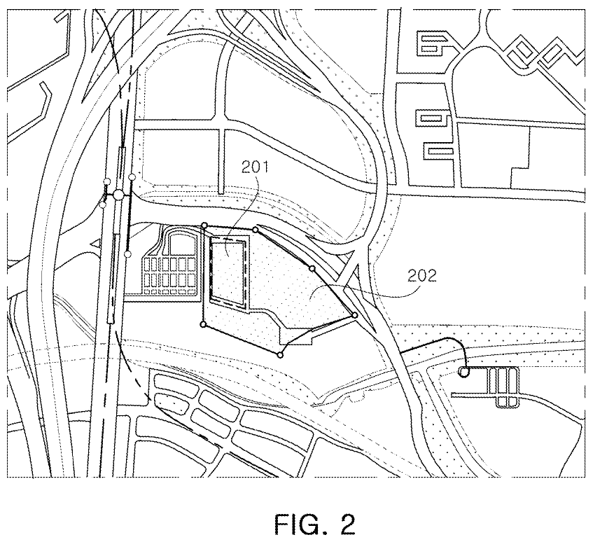

FIG. 2 is a diagram illustratively illustrating a process of setting a geofence area in an update environment.

As illustrated in FIG. 2, the fleet manager may set a garage area 201 as a geofence area on the map, and location information of the set geofence area, for example, GPS information of each vertex or GPS information of the boundary of the garage area 201 may be information of the geofence area. For example, if the name of the garage area 201 is previously defined as, for example, Songpa (name of place) garage, when a Songpa garage is input to the input/output device 131, the geofence area 201 may be automatically set as illustrated in FIG. 2.

Alternatively, the fleet manager may manually set an area 202 expanded from the boundary of the garage area 201 as a geofence area. In this case, the fleet manager may set the geofence area by drawing to include the garage area 201 on the map using the input/output device 131.

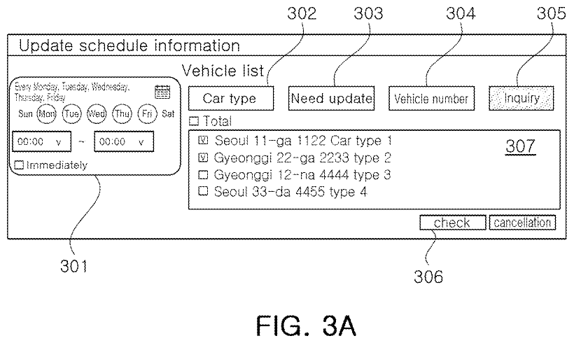

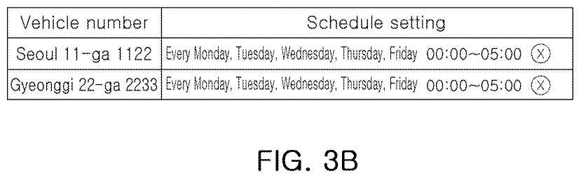

FIG. 3A is a diagram illustratively illustrating a process of setting update schedule information in an update environment.

As illustrated in FIG. 3A, an interface screen for inputting update schedule information through the input/output device 131 may be displayed, and the fleet manager may input update schedule information through this interface screen.

In the interface screen, an update schedule item 301 may set the day of the week to be updated, the time to be updated, or immediately.

When clicking a vehicle type item 302 on the interface screen, a plurality of vehicle types may be displayed. After selecting one or more vehicle types from among a plurality of displayed vehicle types and pressing an inquiry button 305, vehicles of the selected vehicle type may be displayed on a display screen 307 together with vehicle numbers.

When an update item 303 on the interface screen is clicked, a phrase “update required” or “update not required” may be displayed. When the inquiry button 305 is pressed after selecting the phrase “update required,” vehicles requiring an update may be displayed on the display screen 307 together with vehicle numbers. Similarly, when the inquiry button 305 is pressed after selecting the phrase “no update required,” vehicles requiring no update may be displayed on the display screen 307 together with vehicle numbers. Default may be set to “update required.”

In the vehicle number item 304 of the interface screen, the vehicle number to be inquired may be directly input, and then, when the inquiry button 305 is pressed, the vehicle number and vehicle type may be displayed on the display screen 307.

In FIG. 3A, a case in which the phrase “update required” among the update items 303 is clicked is illustrated as an example, and accordingly, vehicle numbers and vehicle types of vehicles requiring updating are displayed on the display screen 307.

After clicking two vehicles on the display screen 307, the desired day and time for update are selected through the update schedule item 301, and then, schedule information may be set for two vehicles by clicking a confirmation button 306.

FIG. 3B is a diagram illustrating an example of an update schedule set for each vehicle according to FIG. 3A.

Referring to FIG. 3B, an update schedule may be set every Monday to Friday from 0:00 to 5:00 for vehicle numbers Seoul 11-ga 1122 and Gyeonggi 22-ga 2233.

The screens and items illustrated in FIGS. 3A to 3B described above are only for helping understanding of the present disclosure, and it should be noted that modifications may be made according to the needs of those skilled in the art.

The aforementioned input/output device 131 may include a pointing device (such as a mouse, trackpad or the like), a keyboard, a touch input device (such as a touchpad, touchscreen or the like), or an output device such as a display device.

The control unit 132 may receive vehicle information from the vehicle terminal 110 through the communication interface 134 to be described later. In this case, the vehicle information may include vehicle number, location information of the vehicle, and parking status.

Thereafter, the control unit 132 may determine whether an Over The Air (OTA) update is required based on vehicle location information included in vehicle information and a preset update environment. In this case, the preset update environment includes only the geofence area set for each vehicle, or may further include update schedule information set for each vehicle in addition to the geofence area.

In some implementations, the control unit 132 may determine that an update is required when the location information of the vehicle is within a geofence area.

Alternatively, in some implementations, the control unit 132 may determine that an update is required when the update status information indicates that an update is required, the parking status is parking, and the current time is included in the update schedule.

When it is determined that an update is required, the control unit 132 may transmit an Over The Air (OTA) update request of vehicle software for a vehicle having a license plate number to the OTA server 120 through the communication interface 134. Thereafter, the OTA server 120 transmits the latest version of the vehicle software to the vehicle terminal 110 of the vehicle having the vehicle number, and the vehicle terminal 110 of the vehicle may update the installed vehicle software of the previous version to the vehicle software of the latest version. On the other hand, also, the control unit 132 may not transmit an Over The Air (OTA) update request when the update status information indicates that the update is not required.

In addition, the control unit 132 may further receive an update result performed by the vehicle terminal 110 through the communication interface 134 described later, and may send a response request to an emergency handling team in case of an update error.

The storage unit 133 may store various programs for implementing the functions performed by the control unit 132 described above.

The communication interface 134 may transmit/receive various types of data described above with the vehicle terminal 110 and the OTA server 120 under the control of the control unit 132.

As described above, in some implementations, when the vehicle is located within a preset geofence area based on vehicle location information, software is updated using OTA update technology, and thus, the firmware software related to safety may be updated without the hassle of visiting a service center separately. In addition, from the point of view of a transportation company with multiple vehicles, collective update for all vehicles of the transportation company may be possible without boarding each vehicle.

In addition, in some implementations, by setting the above-described geofence area as a garage area, quick action may be taken in case of an update failure. In addition, by expanding the above-described geofence area by a certain distance from the boundary of the garage area, update in which the reality of transporters who park vehicles in vacant lots near garages due to the lack of garages is reflected is possible.

In addition, in some implementations, idle time may be significantly reduced by setting the update schedule to a time period during which the vehicle is not operated.

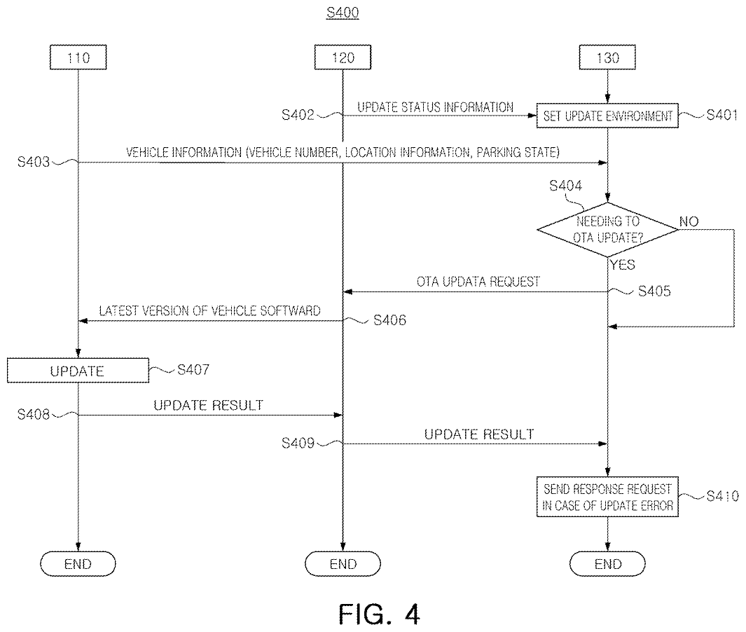

FIG. 4 is a flowchart illustrating a method of updating software for a vehicle based on a geofence.

Hereinafter, a method (S400) of updating software for a vehicle based on geofence will be described with reference to FIGS. 1 to 4. However, for simplicity of the present disclosure, descriptions overlapping with those of FIGS. 1 to 3B are omitted.

Referring to FIGS. 1 to 4, the method (S400) of updating vehicle software based on a geofence may start by setting an update environment (S401).

The update environment may include a geofence area set for each vehicle and update schedule information set for each vehicle. The geofence area may be a garage area or an area extended from the boundary of the garage area. In addition, as described above, the update schedule information may include a vehicle number, update status information indicating whether an update is required, and an update schedule.

The update status information may be received from the OTA server 120 (S402), and as described above, the update schedule information excluding the geofence area and the update status information may be set by the fleet manager through the input/output device 131.

Thereafter, the vehicle terminal 110 may transmit vehicle information to the fleet server 130 (S403).

The vehicle information includes vehicle number, location information, and parking status, and as described above, the parking status may include state information indicating whether or not the vehicle is parked.

Then, the fleet server 130 may determine whether an OTA update is required (S404).

In detail, the fleet server 130 may determine whether an OTA update is required based on vehicle information and the preset update environment.

In some implementations, the fleet server 130 may determine that an update is necessary when the location information of the vehicle is within a geofence area.

In some implementations, when the update status information indicates that an update is required, the parking status is parking, and the current time is included in the update schedule, the fleet server 130 may determine that an update is required.

When it is determined that an update is required, the fleet server 130 may transmit an OTA update request of vehicle software for a vehicle having a license plate number to the OTA server 120 (S405).

Thereafter, the OTA server 120 transmits the latest version of the vehicle software to the vehicle terminal 110 of the vehicle having the vehicle number (S406), and the vehicle terminal 110 may update the installed vehicle software of the previous version to the vehicle software of the latest version (S407). On the other hand, as described above, the control unit 132 may not transmit an Over-The-Air (OTA) update request when the update status information indicates that the update is unnecessary.

The above-mentioned vehicle software is related to the safety of the vehicle and may be firmware software that needs to be updated while parked, but is not limited thereto. For example, as described above, the vehicle software may also be applied to software that may be updated while the vehicle is moving.

Thereafter, the vehicle terminal 110 transmits the update result to the OTA server 120 (S408), and the OTA server 120 may transmit the same to the fleet server 130 (S409).

Thereafter, the fleet server 130 may send a response request to an emergency handling team and the like in case of an update error (S410).

The method (400) of updating software for a vehicle described above may be preferentially performed on only some vehicles among a plurality of vehicles. For example, an update is performed on only some sample vehicles among a plurality of vehicles, and in the case in which there is no problem for a period of time, an update on the rest of the plurality of vehicles may be performed, thereby preventing unexpected results.

As described above, in some implementations, when the vehicle is located within a preset geofence area based on vehicle location information, by updating software using OTA update technology, the firmware software related to safety may be updated without the hassle of visiting a service center separately. In addition, from the point of view of a transportation company with multiple vehicles, all vehicles may be collectively updated without boarding each vehicle.

In addition, in some implementations, by setting the above-described geofence area as a garage area, quick action may be taken in the case of an update failure. In addition, by expanding the above-described geofence area a certain distance from the boundary of the garage area, update may be performed by reflecting the reality of transporters who park vehicles in vacant lots near garages due to a lack of parking space.

In addition, in some implementations, idle time may be significantly reduced by setting the update schedule to a time period during which the vehicle is not operated.

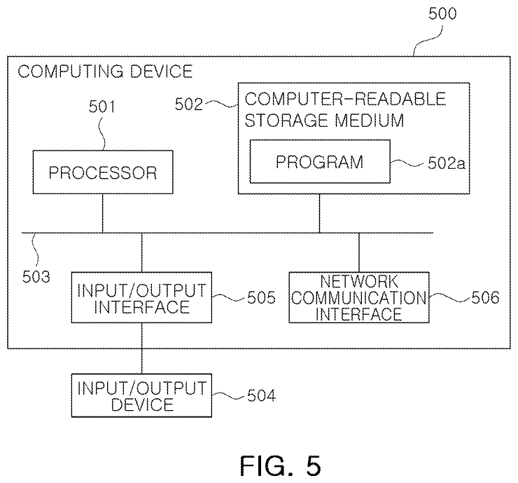

FIG. 5 is a block diagram of a computing device 500 that may fully or partially implement a fleet server, a vehicle terminal, and an OTA server for geofence-based vehicle software update, and may be applied to the vehicle terminal 110, the OTA server 120, and the fleet server 130 illustrated in FIG. 1.

As illustrated in FIG. 5, the computing device 500 includes at least one processor 501, a computer readable storage medium 502 and a communication bus 503.

The processor 501 may cause the computing device 500 to operate according to the above-mentioned example implementations. For example, the processor 501 may execute one or more programs stored in the computer readable storage medium 502. The one or more programs may include one or more computer executable instructions, and the computer-executable instructions may be configured to cause the computing device 500 to perform operations in accordance with an example implementation when executed by the processor 501.

The computer-readable storage medium 502 is configured to store computer-executable instructions or program code, program data, and/or other suitable form of information. A program 502a stored on the computer readable storage medium 502 includes a set of instructions executable by the processor 501. In some implementations, the computer readable storage medium 502 may be a memory (a volatile memory such as random access memory, a non-volatile memory, or a suitable combination thereof), one or more magnetic disk storage devices, optical disk storage devices, flash memory devices, and another form of storage medium that may be accessed by the computing device 500 and store required information, or any suitable combination thereof.

The communication bus 503 interconnects various other components of the computing device 500, in addition to the processor 501 and the computer readable storage medium 502.

The computing device 500 may also include one or more input/output interfaces 505 providing interfaces for one or more input/output devices 504, and one or more network communication interfaces 506. The input/output interface 505 and the network communication interface 506 are connected to the communication bus 503. The network may be any one of cellular networks such as Global System for Mobile Communications (GSM), Enhanced Data Rates for GSM Evolution (EDGE), General Packet Radio Service (GPRS), Code Division Multiple Access (CDMA), Time Division-CDMA (TD-CDMA), Universal Mobile Telecommunications System (UMTS), Long Term Evolution (LTE), or other cellular networks.

The input-output device 504 may be connected to other components of the computing device 500 through the input-output interface 505. Examples of the input/output device 504 may include a pointing device (such as a mouse, a trackpad or the like), keyboard, a touch input device (such as a touchpad, a touchscreen or the like), voice or sound input devices, input devices such as various types of sensor devices and/or imaging devices, and/or output devices such as display devices, printers, speakers, and/or network cards. As an example, the input/output device 504 may be included inside the computing device 500 as a component constituting the computing device 500, and may be connected to the computing device 500, as a separate device distinct from the computing device 500.

On the other hand, implementations may include a program for performing the methods described in this specification on a computer, and a computer readable recording medium including the program. The computer readable recording media may include program instructions, local data files, local data structures, and the like alone or in combination. The media may be those specifically designed and constructed for the present disclosure, or may be those commonly available in the field of computer software. Examples of the computer-readable recording media include magnetic media such as hard disks, floppy disks and magnetic tapes, optical recording media such as CD-ROMs and DVDs, and a hardware device specially configured to store and execute program instructions, such as ROM, RAM, flash memory, and the like. Examples of the program may include high-level language codes that may be executed by a computer using an interpreter, as well as machine language codes generated by a compiler.

As set forth above, in some implementations, when the vehicle is located within a preset geofence area based on vehicle location information, software is updated using OTA update technology. Therefore, the firmware software related to safety may be updated without the hassle of visiting a service center separately. In addition, from the standpoint of a transport company owning a large number of vehicles, all vehicles of the transport company may be collectively updated without boarding each vehicle.

In addition, in some implementations, by setting the above-described geofence area as a garage area, quick action may be taken in the event of an update failure. Also, as the above-described geofence area may be expanded by a certain distance from the boundary of the garage area, update may be performed by reflecting the reality of transporters parking their vehicles in vacant lots near garages due to the lack of garages.

In addition, in some implementations, idle time may be significantly reduced by setting the update schedule to a time period during which the vehicle is not operated.

While example implementations have been illustrated and described above, it will be apparent to those skilled in the art that modifications and variations could be made without departing from the scope of the present disclosure as defined by the appended claims.

What is claimed is:

1. A fleet server configured to perform a software update for a vehicle based on geofence, comprising:
a communication interface;
one or more processors; and
a memory operably connected to the one or more processors and storing instructions that, when executed by the one or more processors, perform operation comprising:
receiving, through the communication interface, vehicle information including a vehicle number and location information of the vehicle,
determining whether an Over The Air (OTA) update of vehicle software is required based on the location information of the vehicle included in the vehicle information and a preset update environment, and
transmitting, based a determination that the OTA update is required, an OTA update request of the vehicle software for a vehicle having the vehicle number, through the communication interface,
wherein the preset update environment includes a geofence area set for each vehicle.

2. The fleet server of claim 1, wherein determining whether the OTA update is required includes determining that the OTA update is required based on the location information of the vehicle indicating that the vehicle is located within the geofence area.

3. The fleet server of claim 2, wherein the preset update environment further includes a vehicle number for each vehicle, update status information indicating whether an update is required, and update schedule information including an update schedule,
wherein the vehicle information further includes a parking state, and
wherein determining whether the OTA update is required includes determining that the OTA update is required, based on the update status information indicating that the update is required, the parking state being parking, and a current time being included in the update schedule.

4. The fleet server of claim 1, wherein the geofence area is a garage area.

5. The fleet server of claim 1, wherein the geofence area is an area expanded from a boundary of a garage area by a predetermined distance.

6. The fleet server of claim 1, wherein the vehicle software is safety-related firmware that is updated based on the vehicle being stationary.

7. The fleet server of claim 1, wherein the OTA update request is transmitted to an OTA server,
wherein the OTA server transmits a latest version of the vehicle software to the vehicle having the vehicle number, and
wherein the vehicle having the vehicle number is configured to update the vehicle software from a prior version to the latest version.

8. The fleet server of claim 3, wherein the operations further comprise, based on the update status information indicating that the update is not required, blocking transmission of the OTA update request.

9. The fleet server of claim 1, wherein the operations further comprise:
receiving an update result, and
transmitting a response request according to the received update result.

10. A method of performing a software update for a vehicle based on a geofence, the method comprising:
receiving vehicle information including a vehicle number and location information of the vehicle;
determining whether an OTA update of vehicle software is required based on the location information of the vehicle included in the vehicle information and a preset update environment; and
transmitting, based on a determination that the OTA update is required, an OTA update request for the vehicle software for a vehicle having the vehicle number,
wherein the preset update environment includes a geofence area set for each vehicle.

11. The method of claim 10, wherein determining whether the OTA update is required includes determining that the OTA update is required based on the location information of the vehicle indicating that the vehicle is located within the geofence area.

12. The method of claim 11, wherein the preset update environment further includes a vehicle number for each vehicle, update status information indicating whether an update is required, and update schedule information including an update schedule,
wherein the vehicle information further includes a parking state, and
wherein determining whether the OTA update is required includes determining that the OTA update is required, based on the update status information indicating that the update is required, the parking state being parking, and a current time being included in the update schedule.

13. The method of claim 10, wherein the geofence area is a garage area.

14. The method of claim 10, wherein the geofence area is an area expanded from a boundary of a garage area by a predetermined distance.

15. The method of claim 10, wherein the vehicle software is safety-related firmware that is updated based on the vehicle being stationary.

16. The method of claim 10, wherein the OTA update request is transmitted to an OTA server,
wherein the OTA server transmits a latest version of the vehicle software to the vehicle having the vehicle number, and
wherein the vehicle having the vehicle number is configured to update the vehicle software from a prior version to the latest version.

17. The method of claim 12, wherein updating the software for a vehicle based on the geofence includes blocking, based on the update status information indicating that the update is not required, transmission of an OTA update request.

18. The method of claim 10, wherein updating the software for a vehicle based on the geofence further comprises:
receiving an update result; and
transmitting a response request according to the received update result.

19. The method of claim 10, wherein the vehicle includes a plurality of vehicles, and
wherein updating the software for a vehicle based on the geofence includes updating the software for one or more vehicles among the plurality of vehicles.

20. A non-transitory computer-readable medium storing a program causing a computer to execute operation comprising:
receiving vehicle information including a vehicle number and location information of the vehicle;
determining whether an OTA update of vehicle software is required based on the location information of the vehicle included in the vehicle information and a preset update environment; and
transmitting, based on a determination that the OTA update is required, an OTA update request for the vehicle software for a vehicle having the vehicle number,
wherein the preset update environment includes a geofence area set for each vehicle.
